(19) United States
(12) Patent Application Publication
(10) Pub. No.: US 2016/0052594 A1
(43) Pub. Date: Feb. 25, 2016

(54) PEDAL-DRIVEN VEHICLE, AND METHOD FOR OPERATING THE PEDAL-DRIVEN VEHICLE

(71) Applicant: ROBERT BOSCH GMBH, Stuttgart (DE)

(72) Inventor: Peter Kimmich, Steinenbronn (DE)

(21) Appl. No.: 14/782,951

(22) PCT Filed: Feb. 13, 2014
(86) PCT No.: PCT/EP2014/052766

§ 371 Date: Oct. 7, 2015

(30) Foreign Application Priority Data
Apr. 8, 2013 (DE) 10 2013 206 163.3

(51) Int. Cl. B62M 6/45; B62M 9/122; B62M 9/132; B62M 25/08

(52) U.S. Cl. CPC B62M 6/45; B62M 25/08; B62M 9/122; B62M 9/132

(57) ABSTRACT

An electric bicycle includes: an electric drive; a power supply; a chain; a gearshift mechanism; an electric actuator for actuating the gearshift mechanism; and a control unit for controlling the electric drive and the electric actuator. The control unit is configured to drive the electric drive in response to a gear shift command in order to move the chain so that a gear shift operation with the aid of the electric actuator is possible.

### BACKGROUND OF THE INVENTION

1. Field of the Invention

The present invention relates to a pedal-driven vehicle, in particular an electric bicycle, and to a method for operating a pedal-driven vehicle.

2. Description of the Related Art

In recent years, bicycles having a conventional pedal drive are increasingly equipped with an electric drive in addition. There are different options for placing the electric drive; the “center motor placement”, in which the electric drive is situated at the crankshaft assembly, offering conceptional advantages, in particular. In addition, a semiautomatic gear shift system is known from the bicycle sector, in which a gear shift operation is able to be triggered by pressing a button or the like, and the gear shift operation is executed by an electric actuator on the gear shift mechanism. These gear shift mechanisms are very comfortable, in particular. One set of problems with the known gear shift mechanisms, which affects both derailleur gears and hub gears, is that the gearshift mechanisms are unable to be operated in standstill mode. After travel using a high gear, it may therefore happen that the high gear is still engaged when the bicycle is at standstill, so that the drive-away is difficult because the engaged gear is too high.

### BRIEF SUMMARY OF THE INVENTION

In contrast, the pedal-driven or muscle-powered vehicle according to the present invention has the advantage that a gear shift operation is possible even when the rider is not pedaling. In the present invention, an electric drive is used to move a chain, so that an unproblematic gearshift operation is possible. To do so, a gearshift mechanism and an electric actuator for operating the gearshift mechanism are provided in addition to the electric drive and a power supply, especially a battery. A control unit controls the electric drive and the electric actuator, the control unit being configured in such a way that the electric drive is actuated in response to a gearshift command, so that the chain is moved so as to enable the gearshift change with the aid of the electric actuator. The present invention therefore allows a gearshift operation to take place without a rider having the operate the pedals for this purpose.

In an especially preferred manner, the control unit is set up in such a way that the chain can be moved out of a standstill state. In other words, the chain is preferably moved by the electric drive when the bicycle is coasting to a stop, for instance. Especially preferably, the gearshift mechanism is shifted to a lower gear from a standstill state, so that an easier initial acceleration is possible after the vehicle has stopped. To avoid incorrect shifting, the gearshift command is carried out from a standstill of the chain exclusively.

Moreover, the vehicle preferably includes a crank assembly sensor which is configured to detect a rider-triggered movement of a crank assembly. The control device is set up to control the electric actuator of the gearshift mechanism in such a way that when no crank movement is detected, the gearshift mechanism switches to a lower gear than the gear currently engaged. Especially preferably, the electric actuator shifts the gearshift mechanism into first gear. In other words, as soon as the crank assembly sensor detects no movement of the crank assembly, i.e., when the rider is not pedaling, the gearshift mechanism is shifted back into a lower gear. This provides the rider with the advantage that a lower gear is already engaged in the gearshift mechanism as soon as the rider starts pedaling again, so that the pedaling can be resumed without any problems. In particular after the vehicle has come to a stop, an initial acceleration is able to be made much easier by the already engaged lower gear.

Moreover, the vehicle according to the present invention preferably includes at least one torque sensor which is configured to detect a torque at the crank assembly applied by a rider. The control device is set up to control the electric actuator of the gearshift mechanism in such a way that if no torque is detected, the gearshift mechanism is shifted into a lower gear than the gear currently engaged. Especially preferably, the torque detection takes place simultaneously with the movement detection of the crank assembly, so that pedaling of the rider or stopping of the rider movement is possible in a redundant manner. The detection of a torque applied by the rider is advantageous in particular insofar as, for example, the rider may still pedal lightly when the vehicle is rolling to a stop without an additional torque being applied in this way. Nevertheless, the speed of the vehicle drops in such a case, so that it would be useful to shift into a lower gear.

According to another preferred development of the present invention, the vehicle moreover includes a semiautomatic shifting device, via which a rider inputs a gearshift command. In addition or as an alternative, the control device is configured to determine an efficiency of the electric drive and to output a gearshift command based on the ascertained efficiency of the electric drive. For example, the efficiency of the electric drive may be recorded as a function of detected parameters, such as the rate of rotation, the output torque of the electric drive, etc.

Moreover, the vehicle preferably includes a velocity sensor for detecting a vehicle velocity, the control unit being set up to select a gear as a function of the vehicle velocity in response to a gearshift command. The control unit, for example, includes a memory in which predefined velocity ranges are stored that are allocated to a predefined gear. At a velocity of zero, i.e., a standing vehicle, for example, the lowest gear may be engaged.

The pedal-driven vehicle is preferably an electric bicycle. Moreover, the electric drive of the electric bicycle is preferably installed as a center drive, i.e., the electric drive is situated in the region of the crank assembly.

It is moreover preferred that the gearshift mechanism of the pedal-driven vehicle is a derailleur gear or a hub gear.

In addition, the present invention relates to a method for operating a pedal-driven vehicle, in which a gearshift command is detected by a control unit in a first step. The electric drive then is powered in order to move the chain, so that a gearshift change may take place. At the same time, a gearshift change is carried out by an electric actuator at the gearshift mechanism. In the method of the present invention, a gearshift operation is therefore able to be realized with the aid of an automatic or semiautomatic gearshift mechanism, although the rider is not pedaling and the chain is actually not moving. The present invention overcomes this by controlling the electric drive, which then moves the chain, so that shifting of the gearshift mechanism, in particular into a lower gear, is possible.

Especially preferably, the chain is moved out of the standstill state by the electric drive. It is furthermore preferred that the electric drive shifts the gearshift mechanism into a lower gear than a gear engaged during the gearshift command. More specifically, if a velocity of the vehicle equals zero, the electric actuator shifts the gearshift mechanism into the lowest gear.

In addition, the gear to be engaged by the gearshift mechanism preferably is engaged as a function of a velocity of the vehicle. In the process, a control unit ascertains a vehicle velocity and compares the detected vehicle velocity to stored vehicle velocities, a predefined gear having been allocated to the stored vehicle velocities in each case. The method according to the present invention is used especially in conjunction with an electric bicycle, in particular a bicycle having a center motor.

### BRIEF DESCRIPTION OF THE DRAWING

FIG. 1 a schematic representation of a vehicle according to a preferred specific embodiment of the present invention.

### DETAILED DESCRIPTION OF THE INVENTION

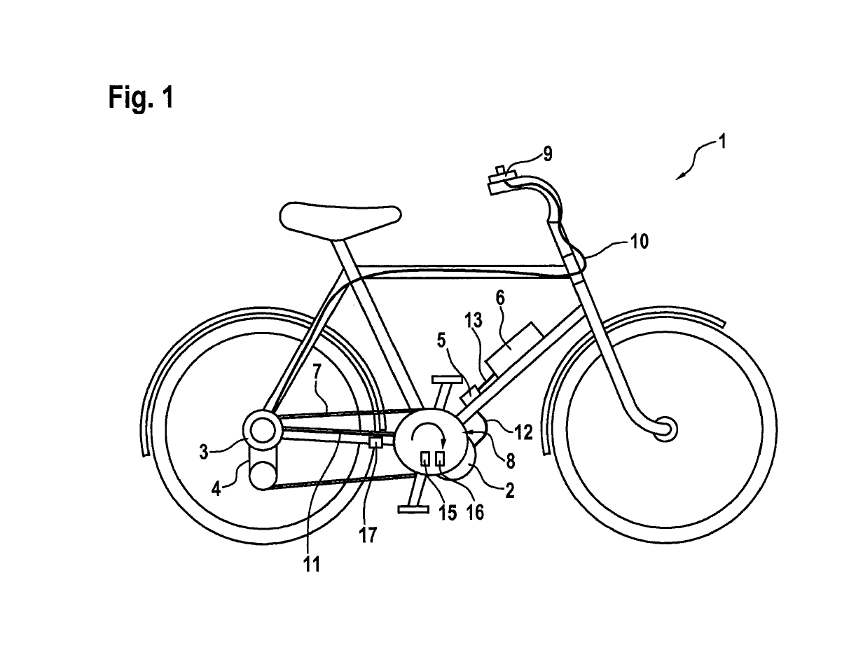

FIG. 1 shows an electric bicycle 1 according to a preferred exemplary embodiment of the present invention.

Electric bicycle 1 according to the invention includes an electric drive 2, which is connected via connecting lines 12, 13 to a control unit 5 and a battery 6 as electrical energy supply. Electric bicycle 1 furthermore includes a gearshift mechanism 4, which is a derailleur gear in this exemplary embodiment. An electric actuator 3 is situated on gearshift mechanism 4 which is connected to control unit 5 via a connecting line 11. Electric actuator 3 switches gearshift mechanism 4 in response to a command from a switch 9, which is disposed on the steering mechanism and connected via a connecting line 10 to electric actuator 3 and control unit 5.

Electric bicycle 1 of this exemplary embodiment thus includes a central control unit 5, which controls all electrically operable devices, i.e., electric actuator 3 and electric drive 2. As an alternative, it would also be possible to provide individual control units for the respective electrically drivable devices.

As can furthermore be gathered from FIG. 1, in this exemplary embodiment electric drive 2 is situated directly on a crankshaft assembly 8, so that a so-called ‘center motor’ is provided in this case.

In addition, electric bicycle 1 includes a multitude of sensors. A crankshaft assembly sensor bearing reference numeral 15 is provided in FIG. 1, which is disposed on crankshaft assembly 8 and records a movement of the crankshaft assembly triggered by a rider via pedals. Crankshaft assembly sensor 15, for example, is able to detect a rotation of a crankshaft. In addition, a torque sensor 16 is provided at crankshaft assembly 8, which records a torque applied by the rider. Torque sensor 16, for example, may include strain gauges or the like. In addition, a velocity sensor 17 is provided, which detects a rotation of a wheel of electric bicycle 1. Based on the rotational speed of the wheel, control unit 5 can then calculate a velocity of the electric bicycle. All sensors are connected to central control unit 5 again.

According to the present invention, control unit 5 is now set up in such a way that electric drive 2 moves chain 7 in response to a gearshift command, so that a gearshift change is possible with the aid of electric actuator 3.

According to the present invention, a gear shift change may occur despite the fact that chain 7 is standing still.

The gear shift command may be input by a rider via switch 9, or control unit 5 may automatically output a gear shift command based on the driving states detected by the sensors. In an especially preferred manner, control unit 5 checks an efficiency of electric drive 2 in the process, so that a shift command is possible based on efficiency aspects. As an alternative, an automatic shift command may be output by control unit 5 also as a function of a pedaling frequency of the rider.

The present invention enables a gear shift operation in a stationary electric bicycle, in particular for the first time. Control unit 5 may be programmed in such a way, for example, that while electric bicycle 1 is coasting to a stop, during which the rider is no longer operating the pedals and chain 7 is standing still, a shift command for down-shifting the gears is able to be output by control unit 5, so that a lower gear is engaged as a function of the driving speed. When electric bicycle 1 then has finally come to a stop, control unit 5 engages the lowest gear, so that the lowest gear is already engaged when the electric bicycle picks up speed again and support via electric drive 2 at an optimal efficiency is able to be provided in the event the rider wishes this. When the bicycle is rolling to a stop without any pedal operation by the rider, control unit 5 may engage an appropriate gear as a function of a speed of the electric bicycle, so that the optimal gear is immediately engaged when the rider resumes pedaling again (even without stopping). An adjustment of gearshift mechanism 4 takes place with the aid of electric actuator 3.

Electric actuator 3 may be supplied with energy via battery 6, or a hub generator is provided in addition, which supplies electric actuator 3 with energy.

The present invention therefore makes it possible to increase the driving comfort considerably, and a shift operation is able to be carried out without assistance by the rider, i.e., without selective pedaling. The shifting operation is performed more rapidly and safely at coordinated speeds, so that an efficiency increase is obtained in shifting. In addition, the stress on the toothed wheel works of the gearshift mechanism and, if provided, a gearing on electric drive 2 is reduced. This also results in less wear of the components of the gearshift mechanism and electric drive 2 as well as the gearing.

1-10. (canceled)

11. An electric bicycle configured to be selectively powered by at least one of electric power and actuation of a pedal by a rider, comprising:
an electric drive;
a power supply unit;
a chain;
a gearshift mechanism;
an electric actuator for actuating the gearshift mechanism; and
a control unit configured to control the electric drive and the electric actuator, wherein the control unit drives the electric drive in response to a gear shift command, in order to move the chain and enable a gear shift change with the aid of the electric actuator.

12. The vehicle as recited in claim 11, wherein the control unit drives the electric drive to move the chain out of standstill.

13. The vehicle as recited in claim 11, further comprising:
a crank assembly sensor configured to detect a rider-triggered movement of the crank assembly;
wherein the control unit is configured to control the electric actuator in such a way that when a standstill of the crank assembly is detected, the gearshift mechanism shifts into a lower gear from the current gear.

14. The vehicle as recited in claim 11, further comprising:
a torque sensor configured to detect a torque applied by a rider;
wherein the control unit is configured to control the electric actuator in such a way that when no torque is detected at the crank assembly, the gearshift mechanism shifts into a lower gear from the current gear.

15. The vehicle as recited in claim 11, further comprising at least one of:
a semiautomatic gearshift mechanism via which a rider inputs a gearshift command; and
an evaluation unit configured to output an automatic gear shift command based on at least one of driving state variables of the vehicle.

16. The vehicle as recited in claim 11, further comprising:
a velocity sensor configured to detect a vehicle velocity;
wherein the control unit is configured to control engaging of a gear as a function of the vehicle velocity in response to a gearshift command.

17. A method for operating electric bicycle configured to be selectively powered by at least one of electric power and actuation of a pedal by a rider, the electric bicycle including an electric drive, a power supply unit, a chain, a gearshift mechanism, an electric actuator for actuating the gearshift mechanism, and a control unit configured to control operation of the electric drive and the electric actuator, the method comprising:
detecting a gear shift command;
driving the electric drive in order to move the chain and enable a gearshift operation; and
executing the gear shift operation with the aid of the electric actuator.

18. The method as recited in claim 17, wherein the electric drive is driven to move the chain out of standstill.

19. The method as recited in claim 17, wherein if at least one of (i) a standstill of a crank assembly is detected, and (ii) no torque applied by the rider is detected at the crank assembly, the gearshift mechanism is shifted into a lower gear from the gear which is engaged when the gear shift command occurred.

20. The method as recited in claim 17, wherein the gear engaged by the gearshift mechanism is engaged as a function of a vehicle velocity.
